(19) United States
(12) Patent Application Publication
(10) Pub. No.: US 2009/0011647 A1
(43) Pub. Date: Jan. 8, 2009

(54) MULTIFUNCTIONAL POWER PLUG

(76) Inventor: Wen-Cheng Lai, Taoyuan (TW)

Correspondence Address: RABIN & Berdo, PC, 1101 14TH STREET, NW, SUITE 500, WASHINGTON, DC, 20005, US

(21) Appl. No.: 11/772,327

(22) Filed: Jul. 2, 2007

(51) Int. Cl. H01R 13/66

(52) U.S. Cl. 439/620.09

(57) ABSTRACT

A multifunctional power plug includes a housing, a plurality of contact blades, a power cable, and a control circuit unit. The housing forms an interior space, which accommodates the control circuit unit therein. The control circuit unit is electrically connected between the contact blades and the power cable. The control circuit unit includes at least a rectification circuit, a voltage regulation circuit, and a timer circuit. The plug may further include a photo-control circuit, which is accommodated in the interior space and is electrically connected to the control circuit unit. As such, besides the functions of voltage bucking and timer setting, the multifunctional power plug also features photo control. The power plug has a simple construction and is easy for mass production to thereby significantly lower manufacturing costs thereof.

### BACKGROUND OF THE INVENTION

1. Field of the Invention

The present invention relates to the field of electrical plug, and in particular to a power plug that features voltage bucking, timer setting, and light-based control for wide applications in household and office electrical devices/appliances and outdoor advertisement illumination and decoration light strings.

2. The Related Arts

Electrical plugs that are currently used in for example household and office electrical devices/appliances, and outdoor advertisement illumination and decoration light strings have been of the same, commonly-known configuration for decades. The conventional structure of the electrical plug includes contact blades that are mounted to an insulation housing. The housing is generally made of plastics by molding, such as injection molding, and then a power cable is fit into and fixed in the housing and set in electrical connection with the contact blades. Finally, a screw is used to fix all the parts together. Such a construction is very simple and thus has only the single function of electrical connection and may have potential risk in safety of use.

To enhance safety of use, some electrical plugs are provided with a fuse that is accommodated in the plug housing. Or alternately, the contact blades are effectively isolated from each other to ensure safety of use. The recent change of plug design, although effective in enhancing the safety of use, still suffers the following drawbacks:

(1) The conventional design of electrical plug provides only a single function.

(2) Voltage bucking cannot be carried out in the conventional plug.

(3) Manual control is necessary for timely connection of power, leading to waste of human power and economic disadvantages.

### SUMMARY OF THE INVENTION

Thus, an objective of the present invention is to provide a multifunctional power plug that features timer setting and voltage bucking and that additionally forms an electrical receptacle on a surface of a housing to allow for additional connection with other plugs so that a single power plug provides various functions.

Another objective of the present invention is to provide a multifunctional power plug featuring photo control and thus applicable to lighting device, such as a decoration light string and advisement illumination, whereby at the day time when the surrounding light is intense, power supplied to the lighting device is automatically cut off and at the night time when the surrounding light is gradually dimmed, power is automatically supplied to the lighting device to timely operate the lighting device without excessive waste of electrical power.

To realize the above objectives, in accordance with the present invention, a multifunctional power plug is provided, comprising a housing, a plurality of contact blades, a power cable, and a control circuit unit. The housing forms an interior space, which accommodates the control circuit unit therein. The control circuit unit is electrically connected between the contact blades and the power cable. The contact blades project out of the housing to serve as a medium for transmission of power.

The control circuit unit comprises a rectification circuit, a voltage regulation circuit, and a timer circuit. The rectification circuit is composed of a resistor and a rectification diode. The regulation circuit is composed of a regulation diode and an electrolytic capacitor. The timer circuit comprises resistors and a timer IC. The control circuit unit further comprises a filter circuit composed of a capacitor.

The present invention will become more obvious from the following description when taken in connection with the accompanying drawings, which show, for purposes of illustration only, a preferred embodiment in accordance with the present invention. In the drawings:

### BRIEF DESCRIPTION OF THE DRAWINGS

FIG. 1 is a side elevational view of a multifunctional power plug in accordance with the present invention in an exploded form;

FIG. 2 is an exploded view of the multifunctional power plug of the present invention; and

FIG. 3 is a circuit diagram of a control circuit of the multifunctional power plug of the present invention.

### DETAILED DESCRIPTION OF THE PREFERRED EMBODIMENT

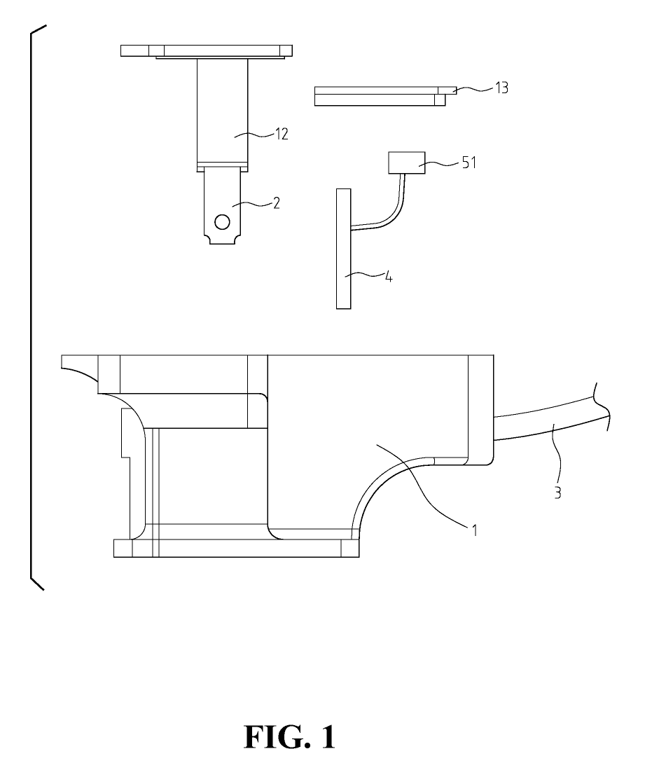

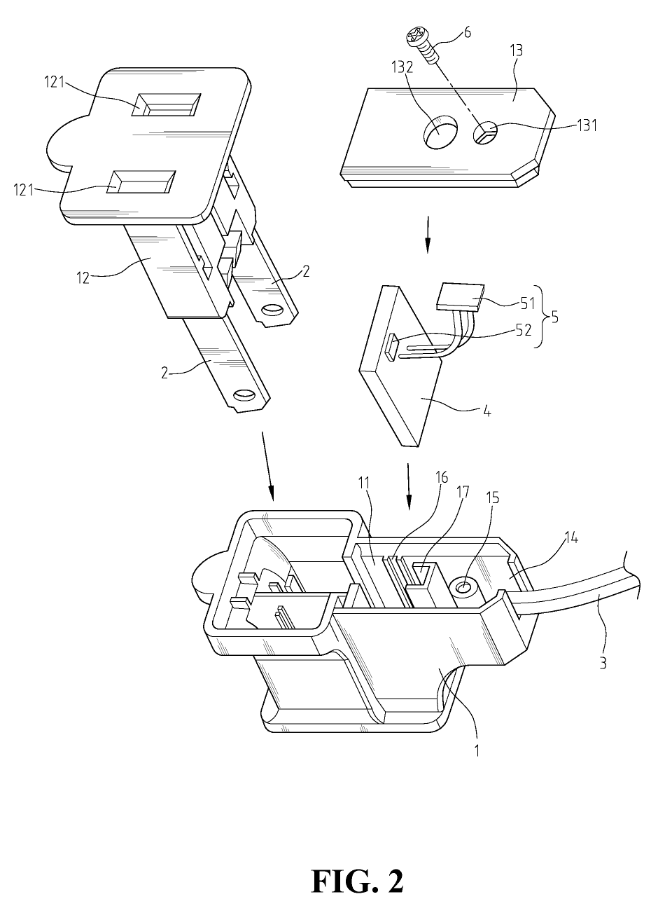

With reference to the drawings and in particular to FIGS. 1 and 2, a multifunctional power plug constructed in accordance with the present invention comprises a housing 1, a plurality of contact blades 2, a power cable 3, and a control circuit unit 4. The housing 1 forms an interior space 11 in which the control circuit unit 4 is received and fixed. The control circuit unit 4 comprises a rectification circuit, a voltage regulation circuit, and a timer circuit. The control circuit unit 4 is electrically connected to the power cable 3 and the contact blades 2. The control circuit unit 4 functions to effect processing for providing a desired voltage or current that meets the requirement for a preset device to the power cable 3. For example, a voltage-bucked direct current can be supplied to for example a light-emitting diode based decoration light string. Or, a voltage-regulated alternate current can be supplied for a household electrical appliance. The timer circuit functions as a switch for time setting, which is of particular advantage for lighting device that has a scheduled lighting period or that has to automatically light up at the night time.

The housing 1 further comprises a contact blade support 12 and a lid 13. The contact blade support 12 has an upper portion forming a plurality of receptacle openings 121 and a lower portion constituted by the contact blades 2 extending from the upper portion. In the embodiment illustrated, the receptacle openings 121 are of rectangular shape and correspond in position to the contact blades 2 so that the upper portion of the contact blade support 12 forms a configuration of an electrical receptacle. The housing 1 is constructed to selectively receive and fix the contact blade support 12 therein with the contact blades 2 of the lower portion of the contact blade support 12 extending out of the housing 1 to form a configuration of an electrical plug. Thus, when the power plug of the present invention is in use, the power plug also provides a receptacle for connection with other electrical device or appliance.

As stated previously, the housing 1 forms an interior space 11, which has an open side to receive the contact blade support 12 as well as the lid 13 to substantially close the open side of the interior space 11. A cable outlet 14 is formed on a side wall of the housing 1 for extension of the power cable 3. The lid 13 and a corresponding portion within the interior space 11 form aligned internally-threaded holes 131, 15, respectively, for the extension of a bolt or screw 6 for threading engagement with the holes 131, 15 to thereby secure the lid 13 to the housing 1. It is noted that, besides the threading engagement, the lid 13 can be secured to the housing 1 in any known means, such as snap-on fitting provided between the lid 13 and the housing 1.

In the embodiment illustrated, the contact blade support 12 carries two contact blades 2, yet it is known that the number of the contact blades is not limited to two, and for example, three contact blades can be alternately used, in which case the receptacle openings 121 formed in the upper portion of the contact blade support 12 is correspondingly set to three respectively associated with the three contact blades 2.

To enhance the use of the power plug of the present invention, the power plug further comprises a photo-control unit 5. The photo-control unit 5 comprises a photo-resistor 51 and a control chip 52. The control chip 52 can be incorporated in the circuit control unit 4, but not necessary to be so. Alternately, the control chip 52 and the circuit control circuit 4 may share the same IC chip. Inside the housing 1, a retention slot 16 and a retainer 17 are formed for respectively receiving/retaining the circuit control unit 4 and the photo-resistor 51 therein. The lid 13 forms a light-transmitting window 132, which can be simply an opening or a transparent glass member that is located corresponding to the photo-resistor 51 to guide external light to the photo-resistor 51. In the embodiment illustrated, the light-transmitting window 132 is embodied as a through hole or opening.

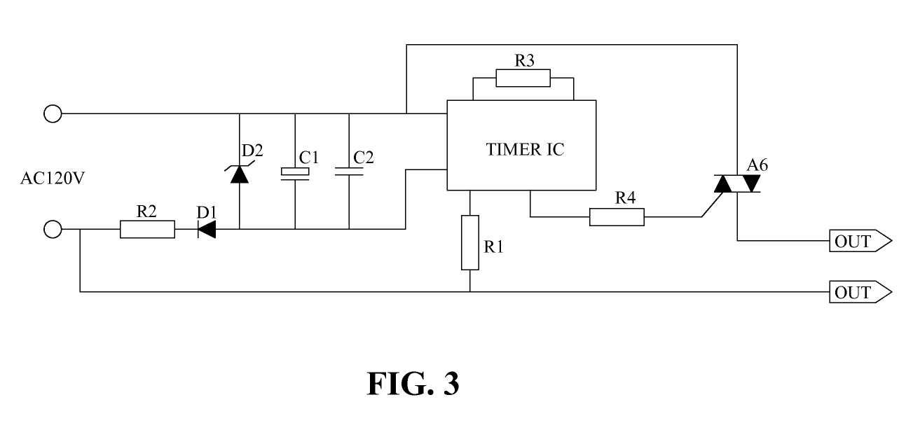

As shown in FIG. 3, a circuit diagram of the power plug in accordance with the present invention is illustrated. The circuit comprises a rectification circuit, a regulation circuit, and a timer circuit. The rectification circuit is composed of an electrical resistor R2 and a rectification diode D1. The regulation circuit is composed of a regulation diode D2 and an electrolytic capacitor C1. The timer circuit comprises resistors R1, R3 and a timer IC. These circuits are interconnected with each other. The control circuit of the power plug further comprises a filter circuit, which is composed of a capacitor C2. The filter circuit is connected in parallel to the regulation circuit.

It is apparent from the above description that the power plug of the present invention incorporates a control circuit unit in the housing thereof for rectification and/or regulation of electrical current supplied therethrough to provide versatile variation of power output for different devices and/or appliances. The power plug is also provided with the features of timing, photo-control, and receptacle configuration, and all these add to the power plug enhanced market competitivity.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A multifunctional power plug comprising a housing, a plurality of contact blades, a power cable, and a control circuit unit, characterized in that the housing forms an interior space in which the control circuit unit is accommodated, the control circuit unit being electrically connected between the contact blades and the power cable, the control circuit unit comprising a rectification circuit and a regulation circuit.

2. The multifunctional power plug as claimed in claim 1 the control circuit unit comprising a timer circuit.

3. The multifunctional power plug as claimed in claim 1 further comprising a photo-control unit that is accommodated in the interior space and comprises a photo-resistor and a control chip, the housing comprising a lid mounted to an open side of the interior space, the lid forming a light-transmitting window located at a position corresponding to the photo-resistor, the photo-control unit being connected to the control circuit unit.

4. The multifunctional power plug as claimed in claim 3, wherein the housing forms a retention slot and a retainer for respectively receiving and retaining the control circuit unit and the photo-resistor.

5. The multifunctional power plug as claimed in claim 1, wherein the control circuit unit further comprise a filter circuit that is connected in parallel with the regulation circuit.

6. The multifunctional power plug as claimed in claim 1, wherein the housing comprises a contact blade support having a lower portion carrying the contact blades and an upper portion forming a plurality of receptacle openings having shape and position corresponding to the contact blades respectively, whereby the upper portion of the contact blade support forms a configuration of an electrical receptacle, the housing being configured to receive and retained the contact plug blade support therein with the contact blades of the lower portion of the contact blade support extending out of the housing to form a configuration of an electrical plug.
